(19) United States
(12) Patent Application Publication
(10) Pub. No.: US 2019/0298593 A1
(43) Pub. Date: Oct. 3, 2019

(54) MOVING DEVICE

(71) Applicant: EXEDY Corporation, Osaka (JP)

(72) Inventors: Hitoshi KATSURA, Osaka (JP); Kazuhito MAEDA, Osaka (JP); Taichi KITAMURA, Osaka (JP); Chika BABA, Osaka (JP)

(73) Assignee: Exedy Corporation

(21) Appl. No.: 16/298,162

(22) Filed: Mar. 11, 2019

(30) Foreign Application Priority Data
Mar. 28, 2018 (JP) 2018-063137

(51) Int. Cl. A61G 5/02; A61G 5/04

(52) U.S. Cl. CPC A61G 5/022; A61G 5/003; A61G 5/042

(57) ABSTRACT

A moving device is disclosed. The moving device includes a vehicle body, a prime mover, mounted on the vehicle body, a driving rotary body and a driven rotary body. The driving rotary body is configured to be driven by the prime mover. The driven rotary body is rotatably mounted on the vehicle body. The driven rotary body has a larger diameter than that of the driving rotary body. The driven rotary body is configured to rotate by contact with the driving rotary body in a rotational direction or by magnetic coupling force of the driving rotary body.

### CROSS-REFERENCE TO RELATED APPLICATIONS

This application claims priority to Japanese Patent Application No. 2018-063137, filed Mar. 28, 2018. The contents of that application are incorporated by reference herein in their entirety.

### TECHNICAL FIELD

The present disclosure relates to a moving device.

### BACKGROUND ART

In a conventional moving device, for example a bicycle, when a motor rotates in a state where a roller is in contact with a wheel, the driving force of the motor is transmitted to the wheel by the roller attached to the motor and the frictional force of the wheel (see, for example, Japan Utility Model Application No. H6-8890). Further, in another conventional moving device, for example an electric wheelchair, the drive force of a motor is transmitted to vehicle wheels in a state where the rotational speed of the motor has been reduced by a planetary gear mechanism therein (see, for example, Japan Laid-open Patent Application Publication No. 2007-28855).

### BRIEF SUMMARY

According to the conventional driving apparatuses for a vehicle, there is disclosed both transmitting drive force of a motor to a vehicle wheel using friction and transmitting drive force of a motor to a vehicle wheel after rotational speed of the motor has been lowered using a planetary gear mechanism

In the case of transmitting the drive force of the motor to the vehicle wheels using friction, for example, transmission efficiency of the drive force of the motor reduces because the vehicle wheels rotate using the rollers and friction of the vehicle wheels. In the case of transmitting rotation of the motor to the vehicle wheels using the planetary gear mechanism, the configuration of the moving device becomes complex because a planetary gear mechanism needs to be used. In this case, the planetary gear mechanism is configured of a plurality of gears meshing together, which causes engagement loss in the plurality of gears and a decrease in the transmission efficiency of the drive force of the motor.

The present advancement has been made in light of the above-mentioned problems and it is an object of the present advancement to provide a moving device with which rotational speed of a prime mover can be reduced and drive force of the prime mover can be efficiently transmitted to a rotary body with a simple configuration.

A moving device according to one aspect of the present advancement includes a vehicle body, a prime mover mounted on the vehicle body, a driving rotary body (a rolling member) configured to be driven by the prime mover, and a driven rotary body. The driven rotary body is rotatably provided to the vehicle body. The driven rotary body has a larger diameter than that of the driving rotary body. The driven rotary body is configured to rotate by contact with the driving rotary body in a rotational direction or by magnetic coupling force of the driving rotary body.

With the present moving device, the driven rotary body, which has a larger diameter than the driving rotary body, rotates by the contact with the driving rotary body in a rotational direction or by the magnetic coupling force of the driving rotary body. As a result, rotational speed of the prime mover can be reduced with a simple configuration. In addition, drive force of the prime mover can be efficiently transmitted to the driven rotary body with a simple configuration.

In the moving device according to another aspect of the present advancement, a first rotational axis of the driving rotary body and a second rotational axis of the driven rotary body are preferably substantially parallel to each other.

With this configuration, the driven rotary body can easily be rotated by the contact with the driving rotary body in the rotational direction or by the magnetic coupling force of the driving rotary body.

In the moving device according to another aspect of the present advancement, a first rotational axis of the driving rotary body and a second rotational axis of the driven rotary body preferably intersect with or skew each other.

With this configuration, the driven rotary body can easily be rotated by the contact with the driving rotary body in the rotational direction or by the magnetic coupling force of the driving rotary body.

In the moving device according to another aspect of the present advancement, the driven rotary body is formed into a substantially annular shape. In this case the driving rotary body is disposed on an inner peripheral portion or an outer peripheral portion of the driven rotary body.

With this configuration, the driven rotary body can easily be rotated by the contact with the driving rotary body in the rotational direction or by the magnetic coupling force of the driving rotary body.

In the moving device according to another aspect of the present advancement, the driven rotary body preferably makes contact with the ground, and the driving rotary body is preferably disposed above the rotational axis of the driven rotary body.

With this configuration, the driven rotary body can suitably be rotated by the contact with the driving rotary body in the rotational direction or by the magnetic coupling force of the driving rotary body.

In the moving device according to another aspect of the present advancement, the driving rotary body preferably includes a first engagement portion. In this case, the driven rotary body includes a second engagement portion configured to engage with the first engagement portion. The driving rotary body and the driven rotary body contact with each other in the rotational direction by engaging the first engagement portion with the second engagement portion.

With this configuration, drive force of the prime mover can be efficiently transmitted to the driven rotary body with a simple configuration.

In the moving device according to another aspect of the present advancement, at least one of a portion at which the driving rotary body contacts the driven rotary body and a portion at which the driven rotary body contacts the driving rotary body is preferably made of metal.

With this configuration, the driven rotary body can be suitably rotated by the contact. In addition, with this configuration, the mechanical strength of the above-described contact portion(s) can be improved, thereby improving the durability of the driving rotary body and the driven rotary body.

In the moving device according to another aspect of the present advancement, at least one of a portion at which the driving rotary body contacts the driven rotary body and a portion at which the driven rotary body contacts the driving rotary body is preferably made of a non-metal material.

With this configuration, the driven rotary body can be suitably rotated by the contact. In addition, with this configuration, the weights of the driving rotary body and the driven rotary body can be reduced by using a material having high specific strength for the above-described contact portion(s).

In the moving device according to another aspect of the present advancement, each of the driving rotary body and the driven rotary body is preferably a magnetic gear.

With this configuration, the drive force of the prime mover can be efficiently transmitted to the driven rotary body with a simple configuration.

In the moving device according to another aspect of the present advancement, the driving rotary body and the driven rotary body are preferably in non-contact with each other.

With this configuration, the drive force of the prime mover can be efficiently transmitted to the driven rotary body with a simple configuration. In addition, since there is no mechanical contact between the driving rotary body and the driven rotary body, any friction and the sound of teeth rattling can be eliminated.

The moving device according to another aspect of the present advancement preferably further comprises a control unit configured to control the prime mover. In this case, the prime mover, the driving rotary body and the control unit are configured as one unit. With this configuration, the moving device can be easily assembled by simply attaching this unit to the vehicle body.

The moving device according to another aspect of the present advancement preferably further comprises a power storage unit configured to store electric power for operating the prime mover. In this case, the prime mover, the driving rotary body, the control unit and the power storage unit are configured as one unit. With this configuration, the moving device can be easily assembled by simply attaching this unit to the vehicle body.

According to the present advancement, the moving device can be configured with a simple configuration, the rotational speed of the prime mover can be reduced, and the drive force of the prime mover can be efficiently transmitted to the rotary body.

### BRIEF DESCRIPTION OF THE DRAWINGS

FIG. 1 is a front view of an electric wheelchair that has adopted a first embodiment of the present disclosure.

FIG. 2 is a side view of the electric wheelchair that has adopted the first embodiment of the present disclosure.

FIG. 3A is a partially enlarged side view for explaining the relationship between a vehicle wheel and a driving rotary body in the electric wheelchair that has adopted the first embodiment of the present disclosure.

FIG. 3B is a partially enlarged cross-sectional view for explaining the relationship between the vehicle wheel and the driving rotary body in the electric wheelchair that has adopted the first embodiment of the present disclosure.

FIG. 4 is a diagram for illustrating a modification example of the electric wheelchair that has adopted the first embodiment of the present disclosure.

FIG. 5 is a diagram for illustrating a modification example of the electric wheelchair that has adopted the first embodiment of the present disclosure.

FIG. 6A is a partially enlarged side view for explaining the relationship between the vehicle wheel and the driving rotary body in an electric wheelchair that has adopted a second embodiment of the present disclosure.

FIG. 6B is a partially enlarged cross-sectional view for explaining the relationship between the vehicle wheel and the driving rotary body in the electric wheelchair that has adopted the second embodiment of the present disclosure.

FIG. 7 is a side view of a vehicle wheel in an electric wheelchair according to another embodiment.

FIG. 8 is a cross-sectional view of a clutch apparatus in the electric wheelchair according to another embodiment.

FIG. 9A is a side view (engaged state) of a toggle mechanism in the electric wheelchair according to another embodiment.

FIG. 9B is a side view (separated state) of the toggle mechanism in the electric wheelchair according to another embodiment.

### DETAILED DESCRIPTION

### First Embodiment

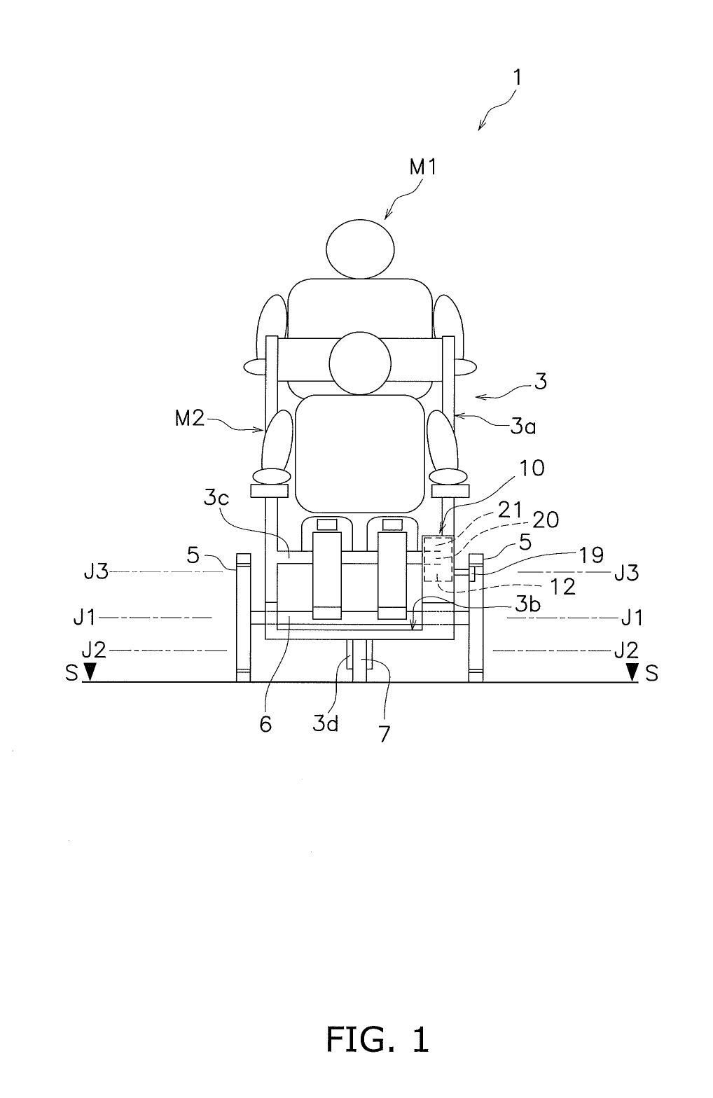

As illustrated in FIG. 1, an electric wheelchair 1 (example of a moving device) that has adopted an embodiment of the present disclosure is configured to enable a caregiver M1 to get thereon and is also configured to be actuated by a motor 12 (example of a prime mover). In addition, the electric wheelchair 1 is configured to move forward and backward.

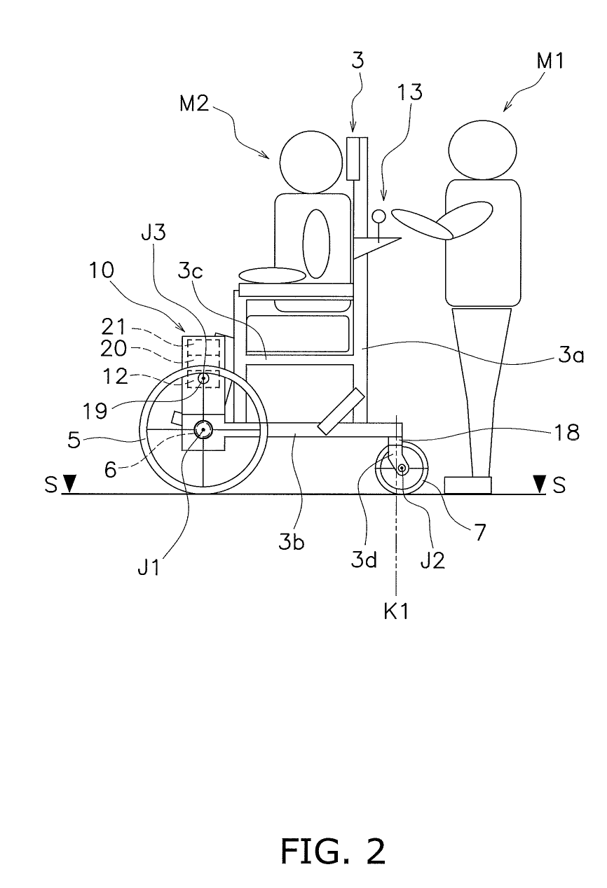

As illustrated in FIGS. 1 and 2, the electric wheelchair 1 includes a vehicle body 3, a pair of front wheels 5 (example of a driven rotary body) and a rear wheel 7. The electric wheelchair 1 also includes a drive unit 10. The electric wheelchair 1 also includes a steering device 18. The electric wheelchair 1 also includes an operating device 13.

### <Vehicle Body>

As illustrated in FIGS. 1 and 2, the vehicle body 3 is configured to enable a care receiver M2 to ride thereon. As illustrated in FIGS. 1 and 2, the vehicle body 3 includes a first frame portion 3a and a second frame portion 3b.

The first frame portion 3a is configured to enable the care receiver M2, who is taken care of by the caregiver M1, to ride thereon. The first frame portion 3a includes a seat portion 3c on which the care receiver M2 sits. The second frame portion 3b supports the first frame portion 3a. The first frame portion 3a is fixed to the second frame portion 3b. The pair of front wheels 5 and the rear wheel 7 are mounted on the second frame portion 3b.

### <Front Wheels>

As illustrated in FIGS. 1 and 2, each of the pair of front wheels 5 is, for example, an annular vehicle wheel. The pair of front wheels 5 is rotatably mounted on the vehicle body 3. In this embodiment, each of the pair of front wheels 5 is rotatably mounted on the second frame portion 3b. The pair of front wheels 5 makes contact with the ground in a state where the pair of front wheels 5 is mounted on the second frame portion 3b. The pair of front wheels 5 is configured to rotate integrally with each other via an axle 6. As a result, both of the front wheels 5 rotate simultaneously when either one of the pair of front wheels 5 rotates. Note that a differential apparatus (not shown) can be provided between the pair of front wheels 5, for example to the axle 6.

Each of the pair of front wheels 5 has a first rotational axis J1. The pair of front wheels 5 is disposed so as to oppose each other in the direction in which the first rotational axis J1 extends (see FIG. 1). The pair of front wheels 5 is provided to the vehicle body 3, for example to the second frame portion 3b, so as to rotate about the first rotational axis J1.

More specifically, the pair of front wheels 5 is mounted on the second frame portion 3b via an axle portion so as to rotate about the first rotational axis J1. Under this state, the pair of front wheels 5 rotates while contacting with a travel surface S. For example, the pair of front wheels 5 rotates by making contact with a driving rotary body 19 (described later) in a rotational direction.

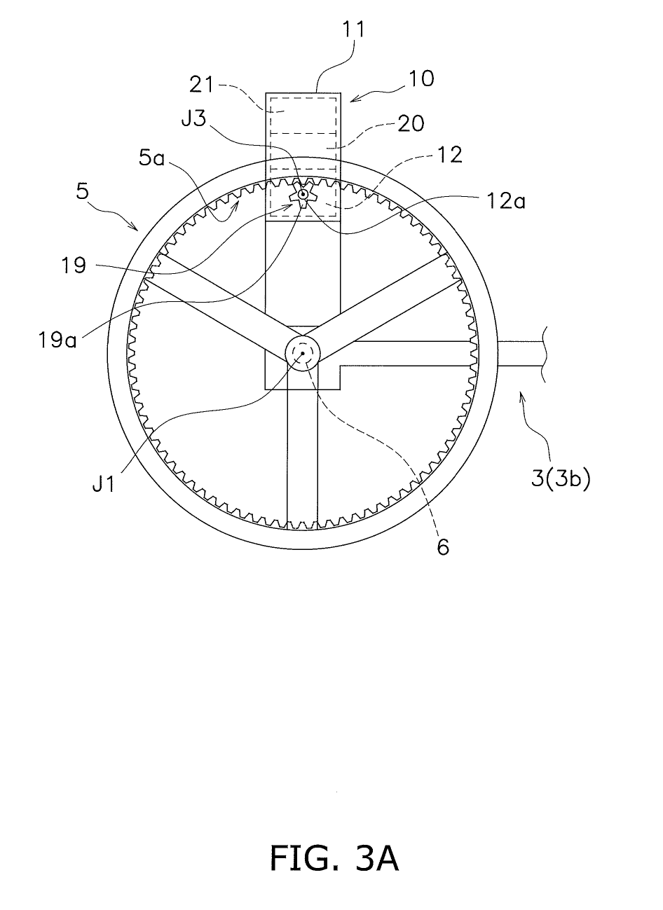

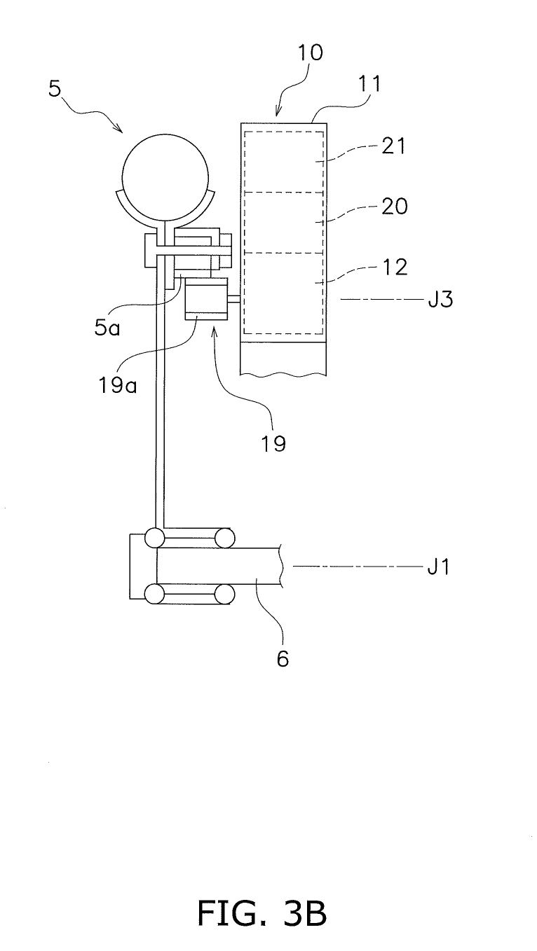

As illustrated in FIGS. 3A and 3B, one of the pair of front wheels 5 includes a first teeth portion 5a (example of a second engagement portion). The first teeth portion 5a is provided on an inner peripheral portion of the front wheel 5. The first teeth portion 5a is fixed to an inner peripheral portion of a wheel (rim) that supports a tire in the front wheel 5. Here, a portion at which the front wheel 5 contacts the driving rotary body 19, for example the first teeth portion 5a, is made of metal.

Note that the first teeth portion 5a can be made of a non-metal material such as a synthetic resin. In this case, the first teeth portion 5a is formed by, for example, integrally providing a synthetic resin belt or a gear having a plurality of teeth onto the inner peripheral portion of the wheel (rim).

The first teeth portion 5a has a plurality of teeth, and these teeth are arranged in a circumferential direction with intervals therebetween. The first teeth portion 5a engages with a second teeth portion 19a (described later) of the driving rotary body 19. More specifically, the first teeth portion 5a meshes with the second teeth portion 19a. As a result, the front wheels 5 rotate when the driving rotary body 19 rotates.

### <Rear Wheel>

As illustrated in FIGS. 1 and 2, the rear wheel 7 is, for example, a vehicle wheel. The rear wheel 7 is mounted on the vehicle body 3, for example, the second frame portion 3b. In this embodiment, the rear wheel 7 is disposed at an interval from the pair of front wheels 5. The rear wheel 7 is mounted on the second frame portion 3b so as to rotate about a second rotational axis J2.

The rear wheel 7 has the second rotational axis J2. The second rotational axis J2 is disposed at an interval from the first rotational axis J1. In this embodiment, the second rotational axis J2 is disposed at an interval from the first rotational axis J1 in a direction orthogonal to the first rotational axis J1. The orthogonal direction is substantially parallel to the travel surface S.

The rear wheel 7 is provided to the vehicle body 3, for example to the second frame portion 3b, so as to rotate about the second rotational axis J2. More specifically, the rear wheel 7 is mounted on the second frame portion 3b via an axle portion so as to rotate about the second rotational axis J2. Under this state, the rear wheel 7 rotates by contacting with the travel surface S.

In addition, as illustrated in FIG. 2, the rear wheel 7 is mounted on the second frame portion 3b so as to rotate about an intersecting shaft K1 which intersects with the second rotational axis J2. More specifically, a vehicle wheel holding portion 3d is mounted on the second frame portion 3b so as to rotate about the intersecting shaft K1.

The vehicle wheel holding portion 3d supports the rear wheel 7 so that the rear wheel 7 rotates about the second rotational axis J2. In other words, the rear wheel 7 is mounted on the second frame portion 3b so as to rotate about the second rotational axis J2 relative to the vehicle wheel holding portion 3d and about the intersecting shaft K1 relative to the second frame portion 3b.

### <Drive Unit>

As illustrated in FIGS. 1 and 2, the drive unit 10 is provided to the vehicle body 3, for example to the second frame portion 3b. As illustrated in FIGS. 3A and 3B, the drive unit 10 includes the motor 12, the driving rotary body 19 and a motor control unit 20 (example of a control unit). In other words, the motor 12, the driving rotary body 19 and the motor control unit 20 are configured as one unit.

More specifically, the drive unit 10 includes the motor 12, the driving rotary body 19, the motor control unit 20 and a battery 21 (example of a power storage unit). In other words, the motor 12, the driving rotary body 19, the motor control unit 20 and the battery 21 are configured as one unit.

More specifically, as illustrated in FIGS. 3A and 3B, the drive unit 10 includes a housing 11 which has an internal space, the motor 12, the motor control unit 20, the battery 21 and the driving rotary body 19. The motor 12, the motor control unit 20, the battery 21 and the driving rotary body 19 are provided in the housing 11 and are configured as one unit.

The motor 12 is disposed inside the housing 11. A rotation shaft 12a of the motor 12 protrudes to the outside from the inside of the housing 11. The motor 12 operates by being supplied with electric power from the battery 21. The motor 12 drives at least one of the front wheels 5 and the rear wheel 7. In this embodiment, the motor 12 drives the front wheels 5. In other words, in this embodiment, the electric wheelchair 1 is a front-wheel drive vehicle.

The motor control unit 20 is configured to control the motor 12. The motor control unit 20 operates by being supplied with electric power from the battery 21. For example, the motor control unit 20 controls rotation of the motor 12 on the basis of an operation signal output from the operating device 13.

The battery 21 stores electric power supplied from an external source (power supply). Here, the battery 21 supplies the motor 12 with electric power to transmit power of the motor 12 to the driving rotary body 19.

The driving rotary body 19 is mounted on a tip of the rotation shaft 12a of the motor 12 so as to rotate integrally with the tip of the rotation shaft 12a. The driving rotary body 19 is disposed outside of the housing 11. The driving rotary body 19 is disposed on an inner peripheral portion or an outer peripheral portion of the front wheels 5. In this embodiment, the driving rotary body 19 is disposed on the inner peripheral portion of the front wheels 5.

The driving rotary body 19 is disposed above the first rotational axis J1 of the front wheel 5. More specifically, a third rotational axis J3 of the driving rotary body 19 is disposed above the first rotational axis J1 of the front wheels 5. The third rotational axis J3 is disposed above the first rotational axis J1 of the front wheels 5 so as to be substantially parallel to the first rotational axis J1 of the front wheels 5.

For example, the driving rotary body 19 is formed into a substantially annular shape. The driving rotary body 19 has a smaller diameter than the front wheels 5. More specifically, the outer diameter of the outermost side of the driving rotary body 19 is smaller than the inner diameter of the innermost side of the front wheels 5.

A tip of the rotation shaft 12a of the motor 12 is mounted on the inner peripheral portion of the driving rotary body 19 so as to rotate integrally with the inner peripheral portion of the driving rotary body 19. The driving rotary body 19 is, for example, a rotary body such as a pulley or a sprocket. The second teeth portion 19a (example of a first engagement portion) is provided on the outer peripheral portion of the driving rotary body 19. The second teeth portion 19a is provided on the outer peripheral portion of the driving rotary body 19.

In this embodiment, a portion at which the driving rotary body 19 contacts the rotary body of each front wheels 5, for example, the second teeth portion 19a is made of metal. Note that the second teeth portion 19a can be made of a non-metal material such as a synthetic resin.

The second teeth portion 19a engages with the first teeth portion 5a. More specifically, the second teeth portion 19a meshes with the first teeth portion 5a. For example, the second teeth portion 19a has a plurality of teeth and each of these teeth is arranged in the circumferential direction with intervals therebetween.

With this configuration, the second teeth portion 19a contacts the first teeth portion 5a in the rotational direction when the driving rotary body 19 rotates. In other words, the driving rotary body 19 contacts the front wheels 5 in the rotational direction.

### <Steering Apparatus>

The steering device 18 is configured to set the steering angle of the rear wheel 7. As illustrated in FIG. 2, the steering device 18 sets the steering angle of the rear wheel 7 by rotating the rear wheel 7 about the intersecting shaft K1. In other words, the travel direction of the electric wheelchair 1 is determined by the steering device 18 setting the steering angle of the rear wheel 7.

The steering device 18 is mounted on the vehicle body 3, for example to the second frame portion 3b. For example, the steering device 18 rotates the rear wheel 7, for example the vehicle wheel holding portion 3d, about the intersecting shaft K1 relative to the second frame portion 3b according to the operation direction of the operating device 13. As a result, the steering angle of the rear wheel 7 is set and the travel direction of the electric wheelchair 1 is determined.

### <Operation Apparatus>

The operating device 13 is used for steering the electric wheelchair 1. The operating device 13 is configured to change the travel direction and velocity of the electric wheelchair 1. As illustrated in FIG. 2, the operating device 13 is configured as a lever member, for example, a joystick.

The operating device 13 is provided to the vehicle body 3, for example, the first frame portion 3a. In this embodiment, the operating device 13 is mounted on a rear portion of the first frame portion 3a. When the operating device 13 is operated by the caregiver M1, a signal corresponding to operation of the operating device 13 is sent to the motor control unit 20.

Note that this embodiment describes a case in which the operating device 13 is operated by the caregiver M1. An operating device (not shown) that is operated by the care receiver M2 can be provided to the vehicle body 3, for example to the first frame portion 3a, separately from the operating device 13 for the caregiver M1.

Through configuring the electric wheelchair 1 as described above, the motor 12 is supplied with electric power from the battery 21 and is controlled by the motor control unit 20 to rotate. Then, rotation of the driving rotary body 19 causes the front wheels 5 having a larger diameter than the driving rotary body 19 to rotate, to thereby operate the electric wheelchair 1. With this configuration, rotational speed of the motor 12 is reduced and the drive force of the motor 12 can be efficiently transmitted to the front wheels 5 with a simple configuration.

### MODIFICATION EXAMPLES

(A) In the first embodiment, there is described an example where the front wheels 5 are driven. Alternatively, the wheels to be driven can be only the rear wheel 7 or can be both the front wheels 5 and the rear wheel 7.

(B) In the first embodiment, there is described an example where the first teeth portion 5a is provided on the inner peripheral portion of the front wheels 5 and the second teeth portion 19a of the driving rotary body 19 engages with the first teeth portion 5a.

Alternatively, the first teeth portion 5a can be provided on the outer peripheral portion of the front wheels 5. In this case, the second teeth portion 19a of the driving rotary body 19 can engage with the first teeth portion 5a by disposing the driving rotary body 19 on a radially outer side of the first teeth portion 5a.

In addition, in this case, the outer diameter of the front wheels 5 is set larger than a tip diameter of the first teeth portion 5a. As a result, the front wheels 5 can contact the travel surface S without the tips of the first teeth portion 5a contacting with the travel surface.

(C) In the first embodiment, there is described an example where a teeth portion (first teeth portion 5a) is provided on the inner peripheral portion of the front wheels 5. Alternatively, a plurality of pin members can be provided on the inner peripheral portion of the front wheels 5 and the second teeth portion 19a can be made to engage with the plurality of pin members. In this case, the plurality of pin members is disposed in the circumferential direction with intervals therebetween. Even with such a configuration, the rotational speed of the motor 12 can be reduced and the drive force of the motor 12 can be efficiently transmitted to the rotary bodies.

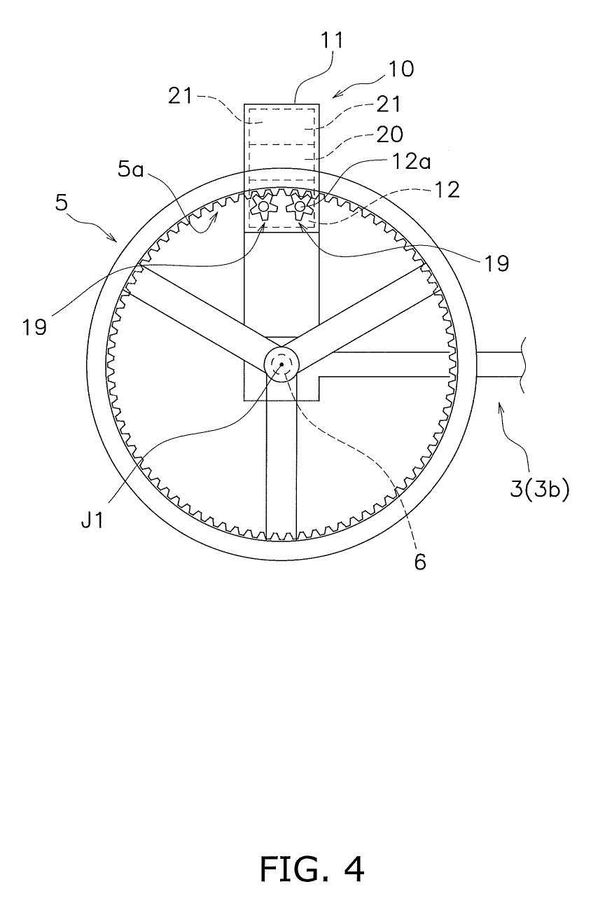

(D) In the first embodiment, there is described an example where one driving rotary body 19 is provided, but there can be a plurality of driving rotary bodies 19. In this case, as illustrated in FIG. 4, the plurality of (two) driving rotary bodies 19 is mounted on the motor 12. Thereby, the front wheels 5 can be driven by a plurality of driving rotary bodies 19.

(E) In the first embodiment, there is described an example where the motor 12 is disposed such that the third rotational axis J3 of the motor 12 is substantially parallel to the first rotational axis J1 of the front wheels 5.

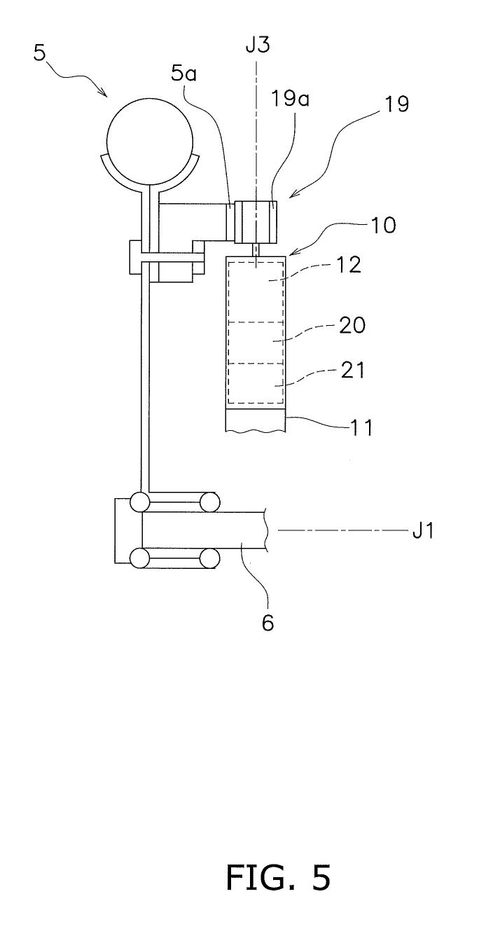

Alternatively, as illustrated in FIG. 5, the motor 12 can be disposed such that the third rotational axis J3 of the motor 12 intersects with or skews the first rotational axis J1 of the front wheels 5. In this case, the first teeth portion 5a or a plurality of pin members are provided on a side of the front wheels 5. The first teeth portion 5a (plurality of teeth) or the plurality of pin members engage with the second teeth portion 19a of the driving rotary body 19.

### Second Embodiment

In a second embodiment, the front wheels 5 and the driving rotary body 19 have different configurations to those of the first embodiment. Therefore, in the second embodiment, only configurations different to those of the first embodiment are described, and any configurations that are the same as the first embodiment are not described. Note that any descriptions omitted in the second embodiment correspond to those in the first embodiment.

### (Front Wheel)

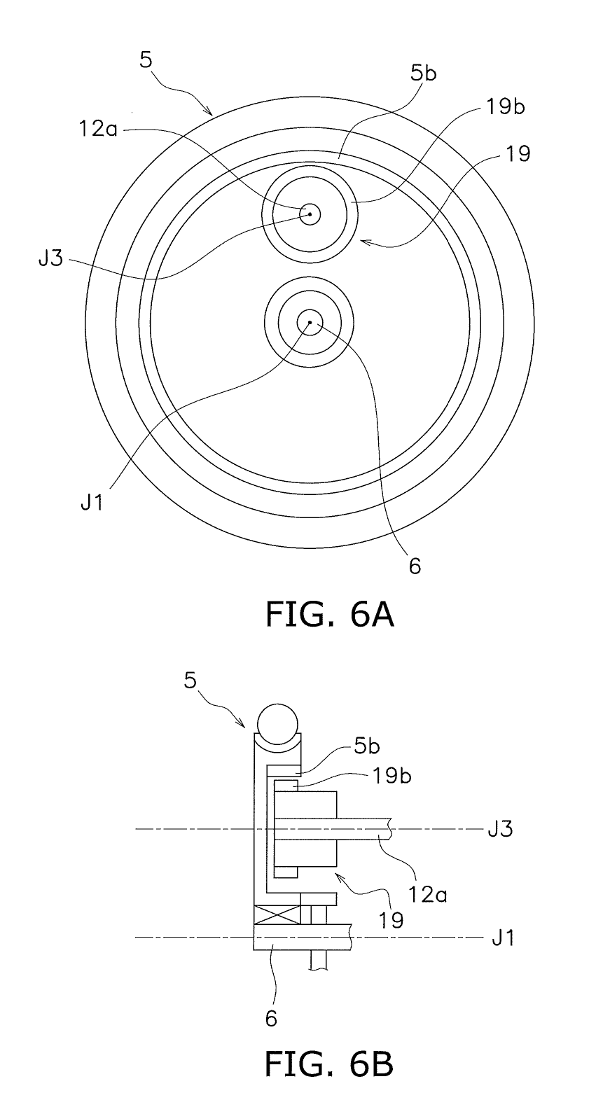

The pair of front wheels 5 rotate by magnetism of the driving rotary body 19, for example, magnetic coupling force. For example, as illustrated in FIGS. 6A and 6B, one of the pair of front wheels 5 has a first magnetic portion 5b. The first magnetic portion 5b is provided on the inner peripheral portion of the front wheels 5. The first magnetic portion 5b is fixed to an inner peripheral portion of a wheel (rim) that supports a tire in the front wheels 5. For example, the first magnetic portion 5b is formed into a substantially annular shape. In the first magnetic portion 5b, N- and S-poles are arranged alternately in the circumferential direction. In other words, the first magnetic portion 5b causes the front wheels 5 to function as an outer ring for a magnetic gear.

### (Rotary Body for Driving)

As illustrated in FIGS. 6A and 6B, the driving rotary body 19 is mounted on a tip of the rotation shaft 12a in the motor 12 so as to rotate integrally with the tip of the rotation shaft 12a. The driving rotary body 19 is disposed on the inner peripheral portion of the front wheels 5. More specifically, the driving rotary body 19 is disposed on the inner peripheral portion of the front wheels 5 without touching the front wheels 5.

For example, the driving rotary body 19 is formed into a substantially annular shape. The driving rotary body 19 has a smaller diameter than the front wheels 5. More specifically, the outer diameter of the outermost side of the driving rotary body 19 is smaller than the inner diameter of the innermost side of the front wheels 5.

The tip of the rotation shaft 12a of the motor 12 is mounted on the inner peripheral portion of the driving rotary body 19 so as to rotate integrally with the driving rotary body 19. A second magnetic portion 19b is provided on an outer peripheral portion of the driving rotary body 19. The second magnetic portion 19b is provided on the outer peripheral portion of the driving rotary body 19.

For example, the second magnetic portion 19b is formed into a substantially annular shape. In the second magnetic portion 19b, N- and S-poles are arranged alternately in the circumferential direction. In other words, the second magnetic portion 19b causes the driving rotary body 19 to function as an inner ring for a magnetic gear.

The outer peripheral portion of the second magnetic portion 19b is disposed so as to face the inner peripheral portion of the first magnetic portion 5b. There is a gap between the outer peripheral portion of the second magnetic portion 19b and the inner peripheral portion of the first magnetic portion 5b. When the driving rotary body 19 rotates in this state, suction force and repulsive force are generated between the first magnetic portion 5b and the second magnetic portion 19b and cause the front wheels 5 to rotate. Through configuring the front wheels 5 and the driving rotary body 19 in this way, the drive force of the motor 12 can be transmitted to the front wheels 5 via the driving rotary body 19 (second magnetic portion 19b).

Through configuring the electric wheelchair 1 as described above, the motor 12 is supplied with electric power from the battery 21 and is controlled by the motor control unit 20 to rotate. Then, rotation of the driving rotary body 19 causes the front wheels 5 having a larger diameter than the driving rotary body 19 to rotate by the magnetic coupling force, to thereby operate the electric wheelchair 1. With this configuration, the rotational speed of the motor 12 is reduced and the drive force of the motor 12 can be efficiently transmitted to the front wheels 5 with a simple configuration.

### Other Embodiments

(1) In the first and second embodiments, there is described an example where one of the pair of front wheels 5 is driven, but both front wheels 5 can be driven individually.

In this case, the steering device 18 can be used to determine the travel direction of the electric wheelchair 1, or the travel direction of the electric wheelchair 1 can be determined, instead of using the steering device 18, by using a difference in rotational speed between the pair of front wheels 5. If determining the travel direction of the electric wheelchair 1 on the basis of the difference in rotational speed between the pair of front wheels 5, the difference in rotational speed between the pair of front wheels 5 is determined according to the operation direction of the operating device 13.

(2) In the first and second embodiments, there is described an example where the battery 21 is disposed in the housing 11, but the battery 21 can be removably disposed in the housing 11. In addition, the battery 21 can be removably mounted on the vehicle body 3 outside of the housing 21.

(3) In the first and second embodiments, there is described an example where the front wheels 5 and the rear wheel 7 are vehicle wheels, but the front wheels 5 and/or the rear wheel 7 can be a rotary body such as a crawler.

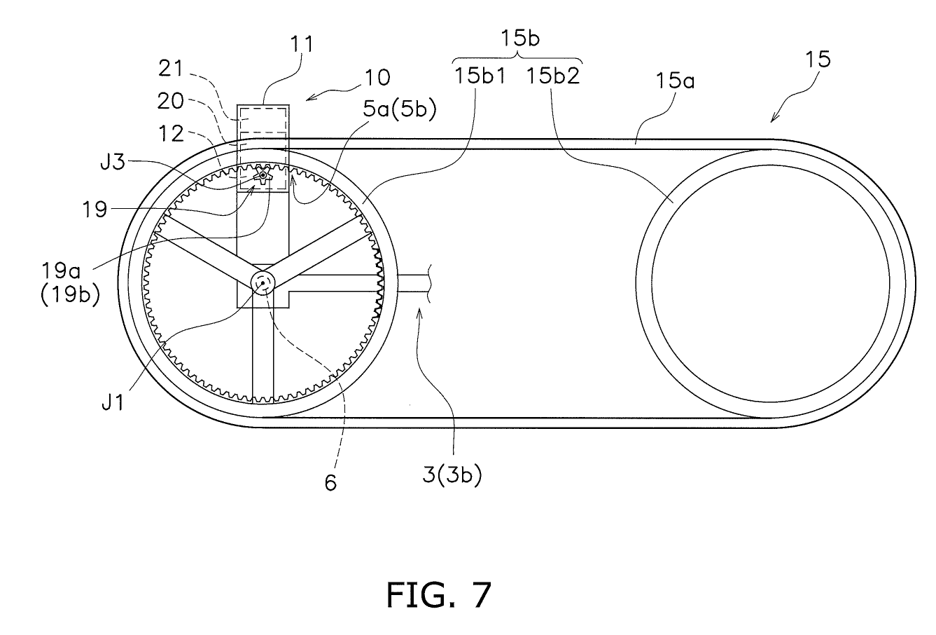

In this case, FIG. 7 illustrates an example where a crawler 15 is used as the front wheels 5. The crawler 15 includes a belt portion 15a and a plurality of (for example, two) drive wheels 15b.

In this example, one of the two drive wheels 15b1 and 15b2, for example the drive wheel 15b1, is formed into a substantially annular shape. In this case, the above-mentioned first teeth portion 5a (or the first magnetic portion 5b) is disposed on the inner peripheral portion of the annular drive wheel 15b1.

The above-mentioned driving rotary body 19 is disposed on the inner peripheral side of the drive wheel 15b1. The second teeth portion 19a (or the second magnetic portion 19b) is disposed on the outer peripheral portion of the driving rotary body 19. Even with such a configuration employing a crawler, the same effects as the first and second embodiments can be achieved.

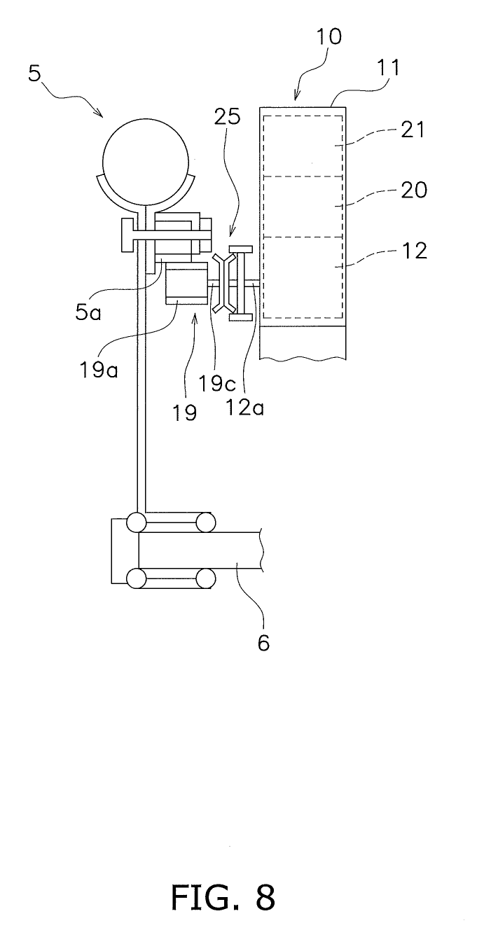

(4) In the first and second embodiments, there is described an example where the drive unit 10 includes the housing 11, the motor 12, the motor control unit 20, the battery 21 and the driving rotary body 19. Alternatively, as illustrated in FIG. 8, the drive unit 10 can include a clutch apparatus 25 in addition to the above-described configuration. The clutch apparatus 25 is disposed between the motor 12 and the driving rotary body 19.

In this case, the clutch apparatus 25 is connected to a tip portion of the rotation shaft 12a of the motor 12 and a rotation shaft 19c is mounted on the driving rotary body 19 so as to rotate integrally with the driving rotary body 19. The rotation shaft 19c is connected to the clutch apparatus 25.

In this example, when the clutch apparatus 25 is on, rotation of the rotation shaft 12a of the motor 12 is transmitted to the rotation shaft 19c via the clutch apparatus 25. As a result, rotation of the motor 12 is transmitted to the driving rotary body 19. Conversely, when the clutch apparatus 25 is off, rotation of the motor 12 is not transmitted to the driving rotary body 19.

Note that the clutch apparatus 25 can be a mechanical clutch or an electromagnetic clutch which can turns on/off the transmission of drive force of the motor 12 to the driving rotary body 19. With this configuration, the electric wheelchair 1 is easier to manually operate when the clutch is off.

(5) In the first and second embodiments, there is described an example where the front wheels 5 rotates by the contact with the driving rotary body 19 in the rotational direction or by the magnetic coupling force of the driving rotary body 19. In addition to the above-described configuration, the electric wheelchair 1 can include a mechanism which causes the driving rotary body 19 to approach the front wheels 5 and separate from the front wheels 5.

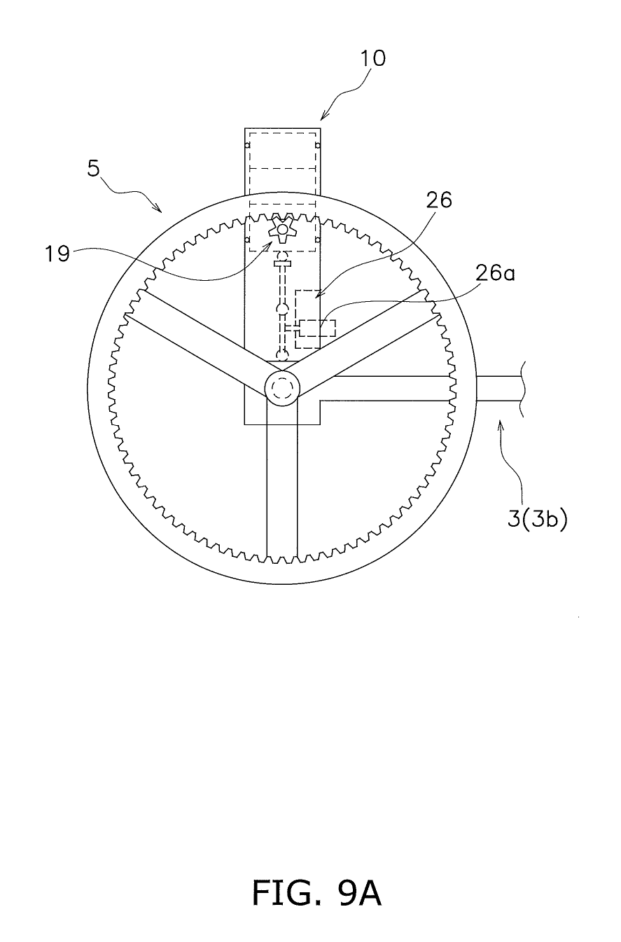

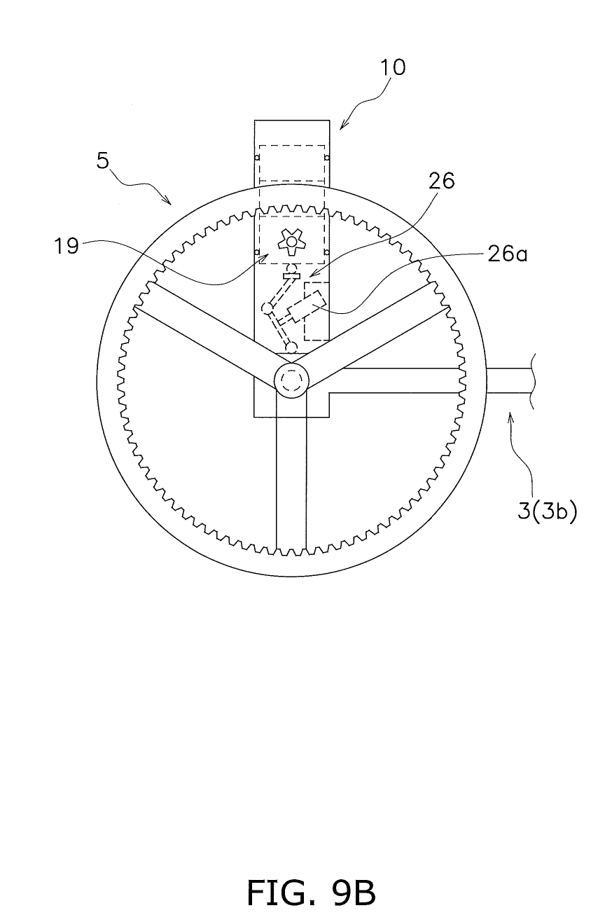

For example, as illustrated in FIGS. 9A and 9B, the driving rotary body 19 can approach or separate from the front wheels 5 by providing a toggle mechanism 26 between the drive unit 10 and the vehicle body 3.

As illustrated in FIG. 9A, the toggle mechanism 26 is operated by pushing and pulling a handle 26a. When the toggle mechanism 26 has caused the driving rotary body 19 to approach and engage the front wheels 5, the front wheels 5 rotate by the contact between the driving rotary body 19 and the front wheels 5 or the magnetic coupling force.

As illustrated in FIG. 9B, when the handle 26a is pushed in this state, the toggle mechanism 26 causes the driving rotary body 19 to separate from the front wheels 5. Then, the contact between the driving rotary body 19 and the front wheels 5 is released. Alternatively, the magnetic effect acting between the driving rotary body 19 and the front wheels 5 is lost. In this case, the front wheels 5 does not rotate even if the driving rotary body 19 rotates.

With this configuration, the driving rotary body 19 can separate from the front wheels 5 and the electric wheelchair 1 can be manually operated more easily.

(6) In the first and second embodiments, there is described an example where the number of front wheels 5 is two and the number of rear wheel 7 is one, but the number of front wheels 5 and rear wheel 7 can be set in any way provided that the total number of front wheels 5 and rear wheel 7 is more than one.

(7) In the first and second embodiments, there is described an example where the front wheels 5 and the rear wheel 7 are vehicle wheels, but the front wheels 5 and the rear wheel 7 can be configured of at least one of vehicle wheels, ball casters, crawlers and omni wheels.

Note that if ball casters are used, the first rotational axis J1 and/or the second rotational axis J2 is defined as the center of the ball that forms the ball caster. If crawlers are used, the first rotational axis J1 and/or the second rotational axis J2 is defined as the center of rotation of one of the plurality of rotating bodies that the crawler includes. In addition, if omni wheels are used, the first rotational axis J1 and/or the second rotational axis J2 is defined as the center of gravity of the omni wheel.

(8) In the first and second embodiments, there is described an example where the motor 12 (motor 12) drives the front wheels 5, but the motor 12 can drive the rear wheel 7.

(9) In the first and second embodiments, there is described an example where the steering device 18 steers the rear wheel 7, but the steering device 18 can steer the front wheels 5.

### REFERENCE SYMBOLS LIST

1 electric wheelchair
3 vehicle body
5 front wheel
7 rear wheel
12 motor
19 driving rotary body
20 motor control unit
21 battery
M1 caregiver
M2 care receiver
5a first teeth portion
5b first magnetic portion
19a second teeth portion
19b second magnetic portion

What is claimed is:

1. A moving device comprising:
a vehicle body;
a prime mover mounted on the vehicle body;
a driving rotary body configured to be driven by the prime mover; and
a driven rotary body rotatably mounted on the vehicle body, the driven rotary body having a larger diameter than that of the driving rotary body, the driven rotary body configured to rotate by contact with the driving rotary body in a rotational direction or by magnetic coupling force of the driving rotary body.

2. The moving device according to claim 1, wherein
a first rotational axis of the driving rotary body and a second rotational axis of the driven rotary body are substantially parallel to each other.

3. The moving device according to claim 1, wherein
a first rotational axis of the driving rotary body and a second rotational axis of the driven rotary body intersect with or skew each other.

4. The moving device according to claim 1, wherein
the driven rotary body has a substantially annular shape, and
the driving rotary body is disposed on an inner peripheral portion or an outer peripheral portion of the driven rotary body.

5. The moving device according to claim 1, wherein
the driven rotary body makes contact with the ground, and
the driving rotary body is disposed above a rotational axis of the driven rotary body.

6. The moving device according to claim 1, wherein
the driving rotary body includes a first engagement portion,
the driven rotary body includes a second engagement portion configured to engage with the first engagement portion, and
the driving rotary body and the driven rotary body contact with each other in the rotational direction by engaging the first engagement portion with the second engagement portion.

7. The moving device according to claim 6, wherein
at least one of a portion at which the driving rotary body contacts the driven rotary body and a portion at which the driven rotary body contacts the driving rotary body is made of metal.

8. The moving device according to claim 6, wherein
at least one of a portion at which the driving rotary body contacts the driven rotary body and a portion at which the driven rotary body contacts the driving rotary body is made of a non-metal material.

9. The moving device according to claim 1, wherein
each of the driving rotary body and the driven rotary body is a magnetic gear.

10. The moving device according to claim 9, wherein
the driving rotary body and the driven rotary body are in non-contact with each other.

11. The moving device according to claim 1, further comprising
a control unit configured to control the prime mover, wherein
the prime mover, the driving rotary body and the control unit are configured as one unit.

12. The moving device according to claim 11, further comprising
a power storage unit configured to store electric power for operating the prime mover, wherein
the prime mover, the driving rotary body, the control unit and the power storage unit are configured as one unit.
